(19) United States
(12) Patent Application Publication
(10) Pub. No.: US 2014/0226310 A1
(43) Pub. Date: Aug. 14, 2014

(54) ELECTRONIC APPARATUS

(71) Applicant: Kabushiki Kaisha Toshiba, Tokyo (JP)

(72) Inventor: Naoki Kuwajima, Hamura-shi (JP)

(73) Assignee: Kabushiki Kaisha Toshiba, Tokyo (JP)

(21) Appl. No.: 14/030,818

(22) Filed: Sep. 18, 2013

Related U.S. Application Data
(63) Continuation of application No. PCT/JP2013/058429, filed on Mar. 22, 2013.

(30) Foreign Application Priority Data
Feb. 13, 2013 (JP) 2013-025735

(51) Int. Cl. G02F 1/1335

(52) U.S. Cl. CPC G02F 1/133608
USPC 362/97.1

(57) ABSTRACT

According to one embodiment, an electronic apparatus includes a housing, a panel, a back light, a sheet and a plurality of frame parts. The panel is within the housing. The back light emits light toward the panel. The sheet is between the panel and the back light. The frame parts are spaced apart from each other between the panel and the sheet.

### CROSS REFERENCE TO RELATED APPLICATIONS

This application is a Continuation Application of PCT Application No. PCT/JP2013/058429, filed Mar. 22, 2013 and based upon and claiming the benefit of priority from Japanese Patent Application No. 2013-025735, filed Feb. 13, 2013, the entire contents of all of which are incorporated herein by reference.

### FIELD

Embodiments described herein relate generally to electronic apparatuses.

### BACKGROUND

An electronic apparatus which displays an image such as a liquid crystal television comprises, for example, a panel which displays an image such as a liquid crystal panel, and a back light unit which illuminates the panel from behind. A middle frame forms a gap between an optical sheet included in the back light unit and the panel.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary front elevation showing an electronic apparatus according to a first embodiment.

FIG. 2 is an exemplary perspective view showing the electronic apparatus in which a housing is disassembled according to the first embodiment.

FIG. 3 is an exemplary perspective view in which a part of the electronic apparatus of the first embodiment is disassembled.

FIG. 4 is an exemplary cross-sectional view showing a part of the electronic apparatus of the first embodiment.

FIG. 5 is an exemplary perspective view showing a back cover of the first embodiment.

FIG. 6 is an exemplary perspective view showing a part of an outer edge region of the back cover of the first embodiment.

FIG. 7 is an exemplary perspective view showing one corner of the outer edge region of the back cover of the first embodiment.

FIG. 8 is an exemplary perspective view showing a pair of frame parts of the first embodiment.

FIG. 9 is an exemplary front elevation showing the back cover to which the frame parts are attached according to the first embodiment.

FIG. 10 is an exemplary perspective view showing the frame parts, a sheet and a first rib according to the first embodiment.

FIG. 11 is an exemplary front elevation showing a back cover and a plurality of frame parts according to a second embodiment.

FIG. 12 is an exemplary front elevation showing a back cover and a plurality of frame parts according to a third embodiment.

FIG. 13 is an exemplary front elevation showing an example of transformation of the back cover and the plurality of frame parts according to the third embodiment.

FIG. 14 is an exemplary front elevation showing a back cover and a plurality of frame parts according to a fourth embodiment.

### DETAILED DESCRIPTION

Various embodiments will be described hereinafter with reference to the accompanying drawings. In general, according to one embodiment, an electronic apparatus includes a housing, a panel, a back light, a sheet and a plurality of frame parts. The panel is within the housing. The back light emits light toward the panel. The sheet is between the panel and the back light. The frame parts are spaced apart from each other between the panel and the sheet.

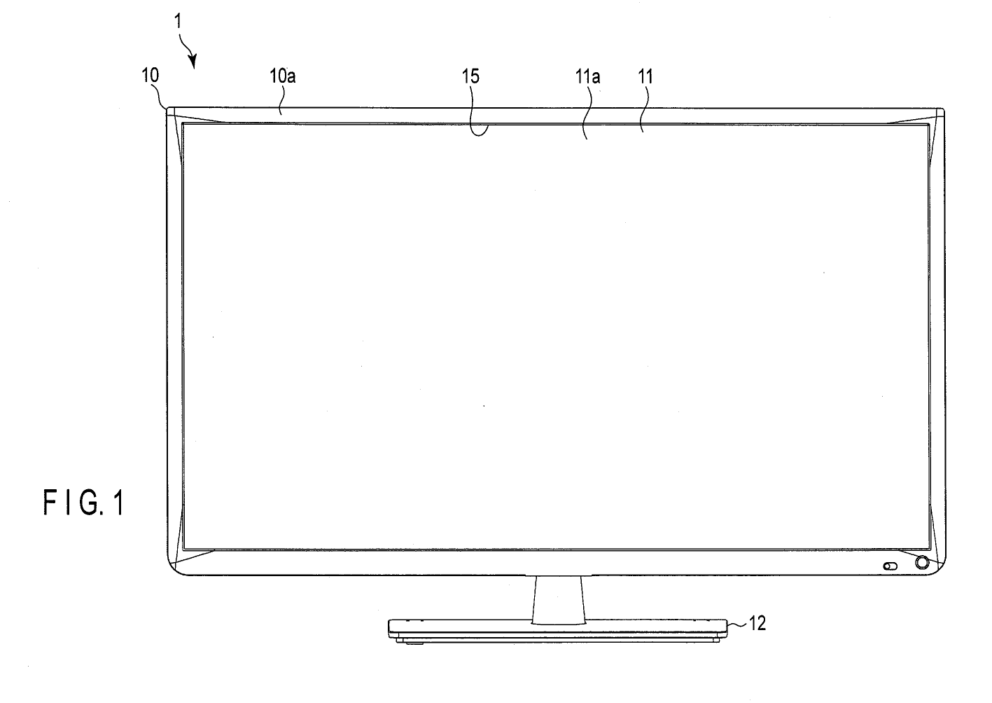

Hereinafter, a first embodiment is explained with reference to FIG. 1 to FIG. 10. In this specification, the near side (i.e., user side) is defined as forward. The far side from the perspective of the user is defined as rearward. The left side from the perspective of the user is defined as leftward. The right side from the perspective of the user is defined as rightward. The upper side from the perspective of the user is defined as upward. The lower side from the perspective of the user is defined as downward. Further, an element which can be expressed in various ways may be described with another or other examples of expression in this specification. However, such an element can be further expressed by other terms which are not shown as the examples. The other elements described without any example can be expressed in various ways. Moreover, each figure schematically shows an embodiment, and the dimension of each element shown in drawings may be different from the explanations of the embodiments.

FIG. 1 is a front view showing an electronic apparatus 1 related to the first embodiment. The electronic apparatus 1 is a liquid crystal television, and could be also expressed as, for example, a television receiver, a display unit or a display device. The electronic apparatus is not limited to the above examples, and may be a different type of apparatus such as any other type of thin-screen television, a personal computer, a mobile phone, a smartphone and a car navigation device.

As shown in FIG. 1, the electronic apparatus 1 comprises a housing 10, a panel 11 and a stand 12. The panel 11 is a liquid crystal panel, and could be also expressed as, for example, a display portion, a component or a cell. The panel 11 is not limited to these examples, and may be any other panel which displays an image. In this specification, the term “image” encompasses a still image and a moving image.

The housing 10 is formed into a substantially rectangular box-shape, and houses the panel 11. The housing 10 comprises a rectangular display opening 15. The display opening 15 opens on a front surface 10a of the housing 10. The display opening 15 exposes a screen surface 11a of the panel 11 to the outside. The screen surface 11a may be covered by a translucent plate such as a glass plate and an acrylic plate.

The panel 11 is formed into a rectangular plate-shape, and comprises, for example, a liquid crystal layer, a pair of glass plates sandwiching the liquid crystal layer, and a pair of polarizing plates piled on the glass plates respectively. For example, a source substrate and a driver IC are connected to an edge of the panel 11. The panel 11 displays an image on the screen surface 11a by, for example, being controlled by the driver IC. The user can view the image displayed on the screen surface 11a of the panel 11 through the display opening 15.

The stand 12 is removably attached to the housing 10. The stand 12 is placed on, for example, a television table, and rotatably supports the housing 10. The housing 10 is not limited to this structure. The stand 12 may be removed, and the housing 10 may be put on a wall without the stand 12.

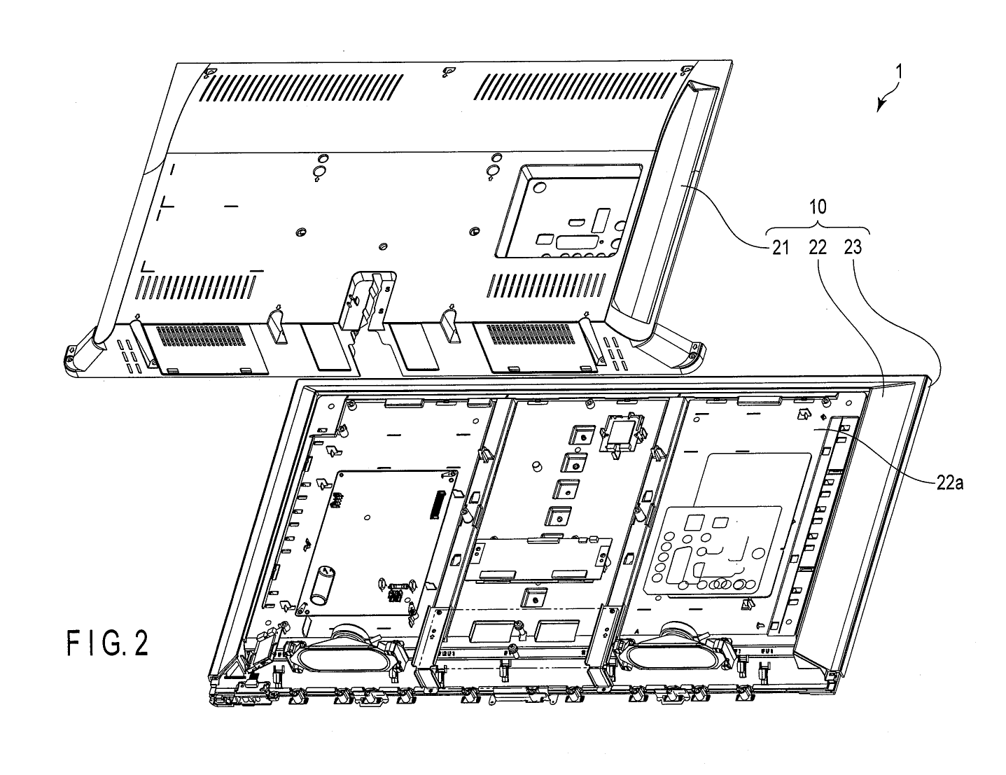

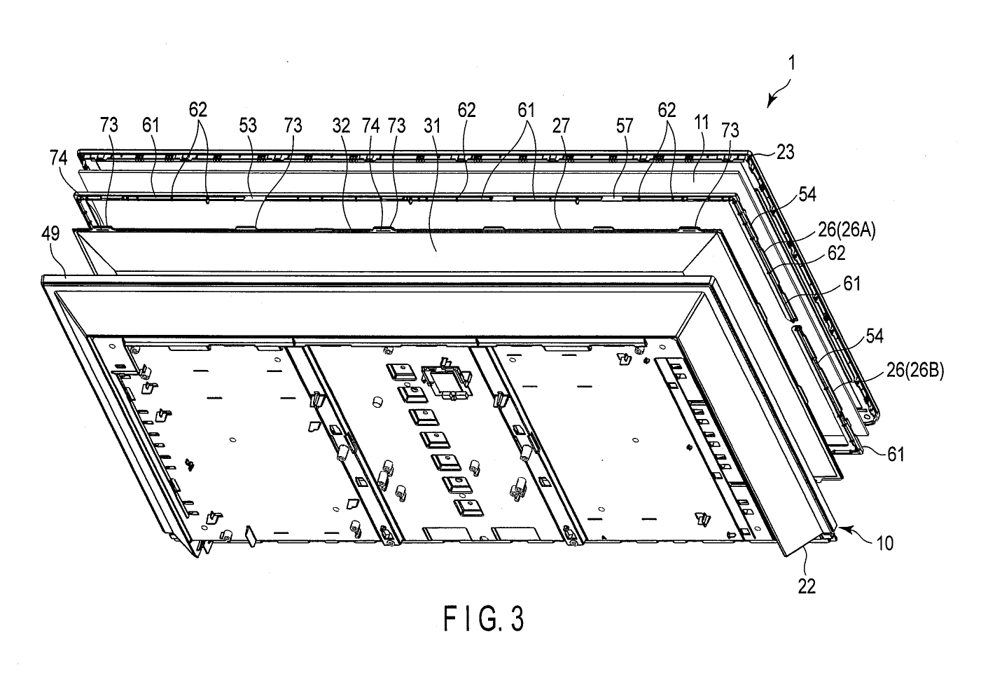

FIG. 2 is a perspective view showing the electronic apparatus 1 from rearward. In FIG. 2, the housing 10 is disassembled. FIG. 3 is a perspective view showing a part of the electronic apparatus 1. In FIG. 3, the part is disassembled. As shown in FIG. 2, the housing 10 comprises a unit cover 21, a back cover 22 and a front cover 23. The back cover 22 could be also expressed as, for example, a housing portion, a wall or a cover. The front cover 23 could be also expressed as, for example, a front bezel or a mask.

The unit cover 21 is attached to an outer surface 22a of the back cover 22 by, for example, claws and screws. The unit cover 21 covers a part of the outer surface 22a of the back cover 22. The other portions of the outer surface 22a of the back cover 22 are exposed to the outside. Various components such as a circuit board and a speaker are attached to the outer surface 22a of the back cover 22. These components are covered by the unit cover 21.

As shown in FIG. 3, the back cover 22 is attached to the front cover 23 by, for example, claws and screws. The panel 11, a pair of frame parts 26, and a back light unit 27 are housed in the back cover 22 and the front cover 23 which are combined with each other. The frame parts 26 could be also expressed as, for example, middle frames or intermediate members.

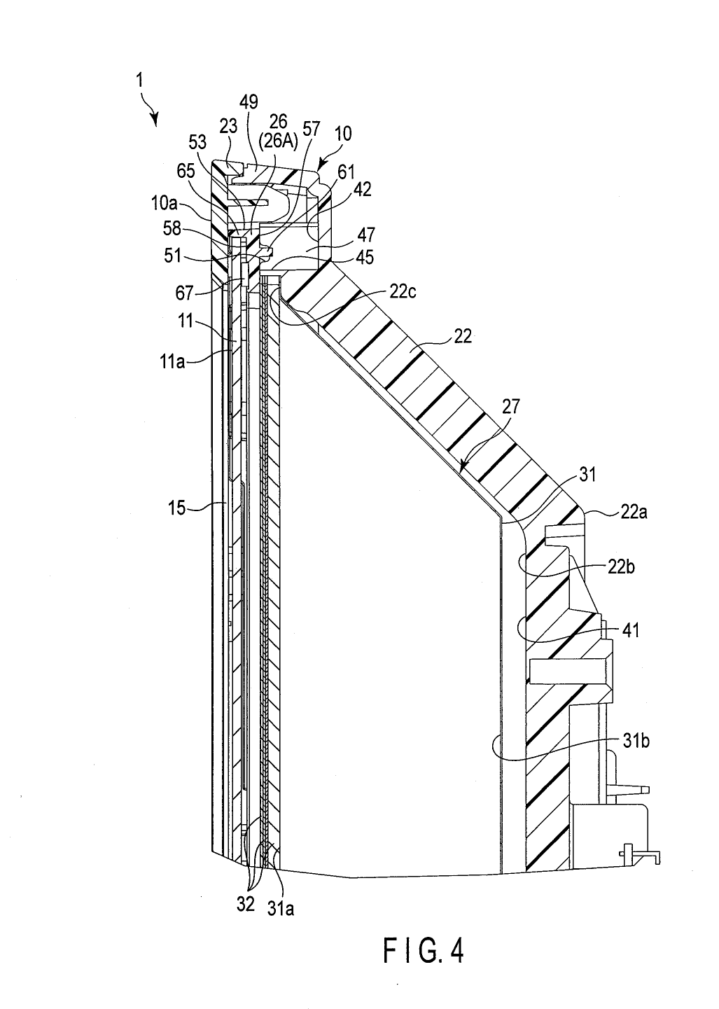

FIG. 4 is a cross-sectional view showing a part of the electronic apparatus 1 except for the unit cover 21. As illustrated in FIG. 4, the back light unit 27 comprises a reflector 31 and a plurality of sheets 32. Each of the sheets 32 is a polarizing sheet or a prism sheet. The polarizing sheet or the prism sheet could perform various optical functions. For example, each of the sheets 32 could be also expressed as an optical sheet.

The reflector 31 is formed into a substantially box-shape comprising an opening end 31a. The opening end 31a is a rectangular opening. The reflector 31 is attached to the back cover 22 along an inner surface 22b of the back cover 22. The inner surface 22b of the back cover 22 is opposite to the outer surface 22a. The opening end 31a of the reflector 31 faces the front cover 23.

The plurality of sheets 32 are piled each other and cover the opening end 31a of the reflector 31. In other words, the plurality of sheets 32 face a bottom surface 31b of the reflector 31 through a gap. The bottom surface 31b of the reflector 31 is opposite to the opening end 31a.

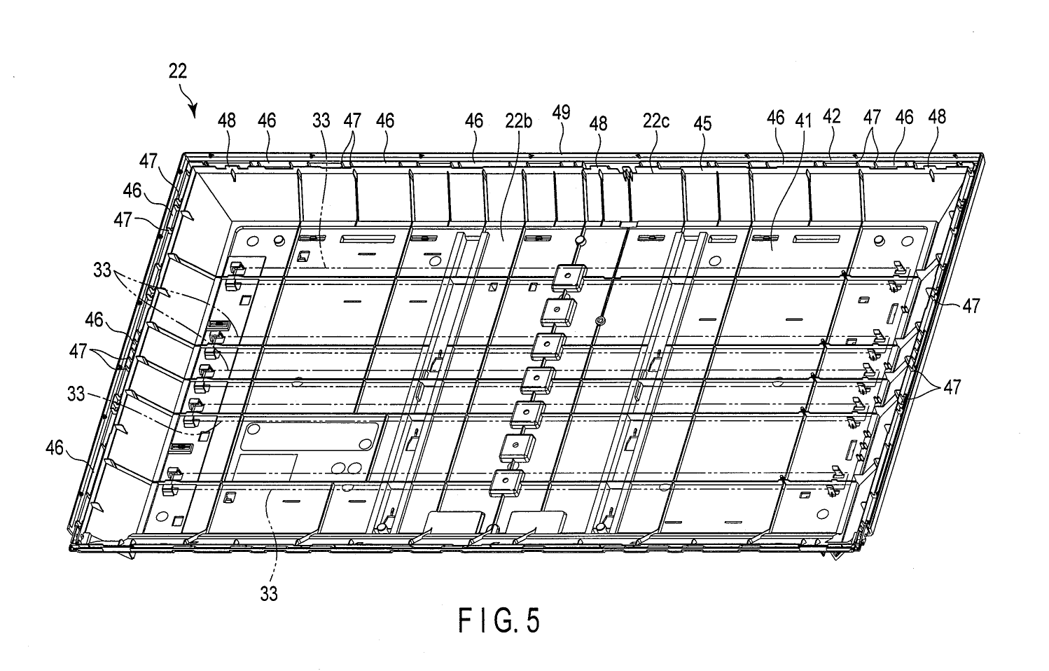

FIG. 5 is a perspective illustration showing the back cover 22. As shown by two-dot chain lines in FIG. 5, a plurality of back lights 33 are on the inner surface 22b of the back cover 22. The back light unit 27 comprises the back lights 33.

Each of the back lights 33 is a direct downward type (direct type) of back light, and comprises a square circuit board comprising a plurality of LEDs. Each of the back lights 33 is not limited to this example, and may be, for example, an edge light type of back light comprising a light guiding plate and a plurality of LEDs on an end surface of the light guiding plate.

The circuit board of each back light 33 is between the reflector 31 and the back cover 22. The LEDs of the back lights 33 are, for example, inserted into holes of the reflector 31, and protrude from the bottom surface 31b of the reflector 31. Thus, the LEDs are between the bottom surface 31b of the reflector 31 and the sheets 32.

The back cover 22 is formed into a substantially box-shape comprising an opening end 22c. The back cover 22 comprises a central region (main body region) 41 hollowed in a frustum shape, and a flanged outer edge region 42 along an outer edge of the back cover 22. The outer edge region 42 is in a circumference of the central region 41. The outer edge region 42 surrounds the central region 41 from the upper side, the right side and the left side. In other words, the outer edge region 42 surrounds the opening end 22c of the back cover 22. The outer edge region 42 is formed into a frame shape having a predetermined width.

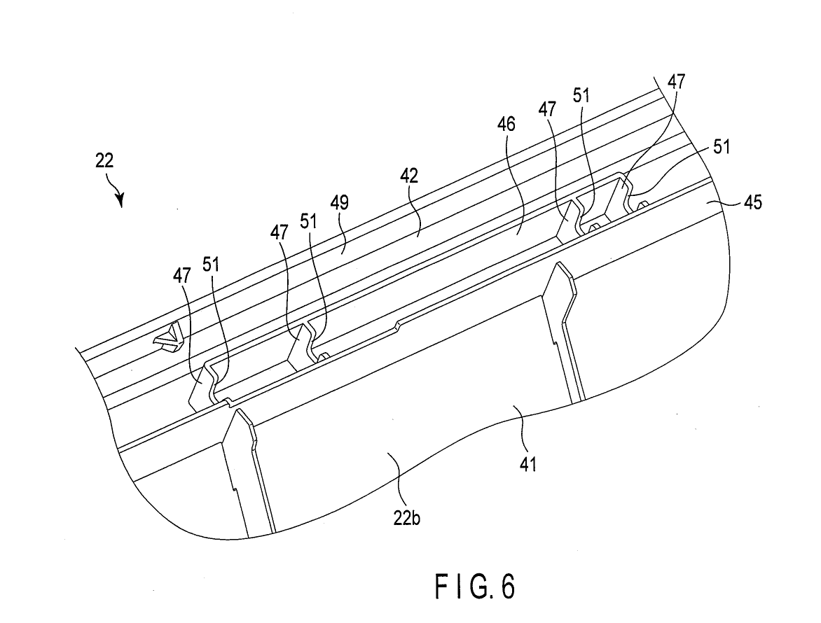

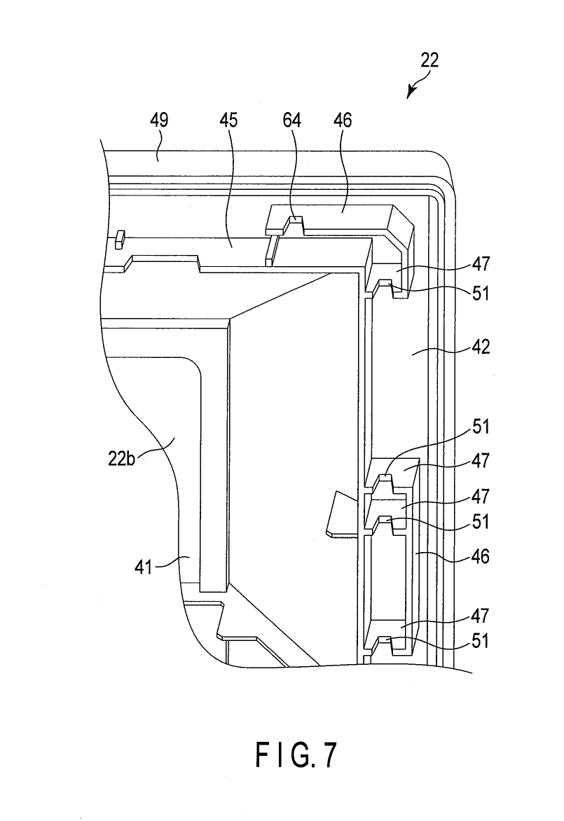

FIG. 6 is a perspective illustration showing a part of the outer edge region 42 of the back cover 22. FIG. 7 is a perspective illustration showing one corner of the outer edge region 42 of the back cover 22. As indicated in FIG. 6 and FIG. 7, the back cover 22 comprises a first rib 45, a plurality of second ribs 46, a plurality of third ribs 47, and an outer frame 49.

The first rib 45 is on a border between the central region 41 and the outer edge region 42. The first rib 45 continuously extends along the border between the central region 41 and the outer edge region 42. The first rib 45 improves the stiffness of the back cover 22 overall, and is also utilized for determining the position of the reflector 31.

Each of the plurality of second ribs 46 extends along the first rib 45 within the outer edge region 42. Each of the second ribs 46 extends substantially in parallel with the first rib 45. However, as shown in FIG. 7, at a corner of the outer edge region 42, the second rib 46 includes a portion extending at a slant with respect to the first rib 45.

The third ribs 47 are integrally formed with the first rib 45 and the second ribs 46. The third ribs 47 extend in a direction substantially orthogonal to the first rib 45 and the second ribs 46. The third ribs 47 connect the first rib 45 and the second ribs 46.

The outer frame 49 extends along an outer circumferential edge of the outer edge region 42. The outer frame 49 protrudes largely compared with the first to third ribs 45 to 47. An inner surface of the outer frame 49 comprises, for example, the claws which engage with the front cover 23.

The first to third ribs 45 to 47 are provided in a substantially circular shape. For example, as indicated in FIG. 6, at a position except for the corners of the outer edge region 42, the first to third ribs 45 to 47 are provided in a substantially quadrangular shape (box shape). On the other hand, as illustrated in FIG. 7, at the corner of the outer edge region 42, the first to third ribs 45 to 47 are provided in a substantially polygonal shape (bag shape) including a portion of a substantially double-L-shape. Thus, the substantially circular shape encompasses the substantially quadrangular shape, the substantially box shape, the substantially polygonal shape and the substantially bag shape.

In this specification, the substantially circular shape does not require that the first to third ribs 45 to 47 should be fully continuous. Instead, the substantially circular shape means that the first to third ribs 45 to 47 are substantially continuous. Thus, the first to third ribs 45 to 47 may be partially discontinuous.

As shown in FIG. 5, the first rib 45 comprises a plurality of projections 48. The projections 48 are an example of a first engaging portion. The projections 48 protrude largely compared with the other regions of the first rib 45. The projections 48 are in the first rib 45 of the upper side of the outer edge region 42, and the first rib 45 of the lower side of the outer edge region 42. The sides of the outer edge region 42 are a part of the outer edge region 42, and linearly extend. The projections 48 may be in the first rib 45 of the right and left sides of the outer edge region 42.

As shown in FIG. 6, at least some of the plurality of third ribs 47 each comprise an engaging portion 51. The engaging portion 51 is a notch (groove) in the third rib 47. The engaging portions 51 in the plurality of third ribs 47 are set out in a rectangular frame-shape.

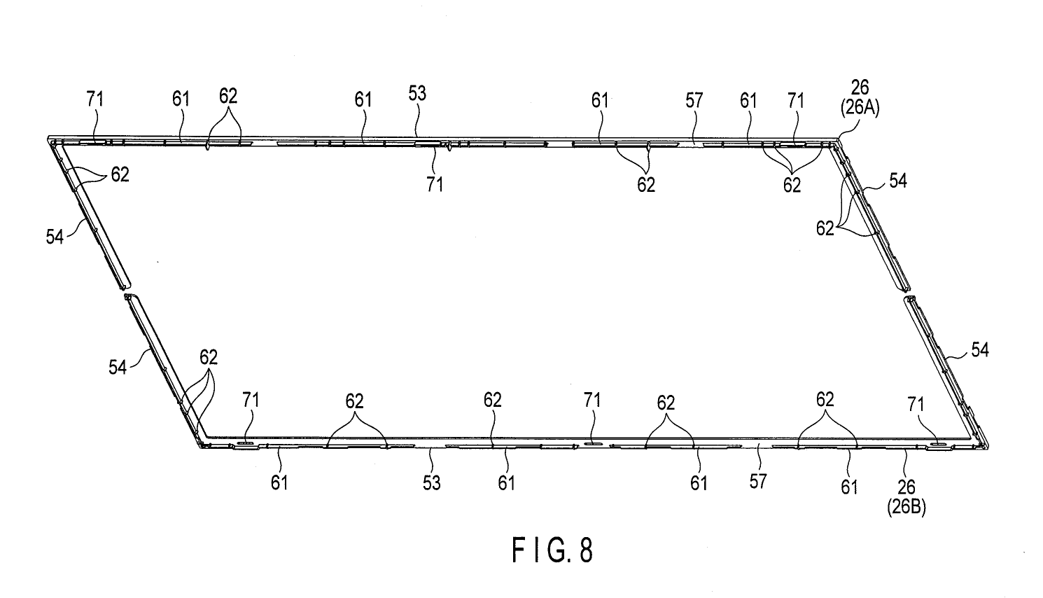

FIG. 8 is a perspective illustration showing the pair of frame parts 26. As illustrated in FIG. 8, the frame parts 26 comprise an upper frame part 26A and a lower frame part 26B. In the following descriptions, when explanations are common to the upper frame part 26A and the lower frame part 26B, the upper frame part 26A and the lower frame part 26B are inclusively referred to as “frame part 26”.

Each of the pair of frame parts 26 comprises a first portion 53 and a pair of second portions 54. The first portion 53 is a portion extending in a lateral direction, and could be also referred to as a long side portion, a long scale portion, or a basal portion. The second portions 54 are portions extending in a longitudinal direction, and could be also referred to as short side portions, short scale portions, or extending portions.

Each of the first and second portions 53 and 54 is formed into a rectangular plate-shape (bar-shape). The first portion 53 is longer than each of the second portions 54. Each of the pair of second portions 54 extends in a substantially same direction from a corresponding end of the first portion 53. Therefore, the pair of second portions 54 extends substantially in parallel with each other. The second portions 54 are substantially orthogonal to the first portion 53. Thus, the frame part 26 is formed into a U-shape.

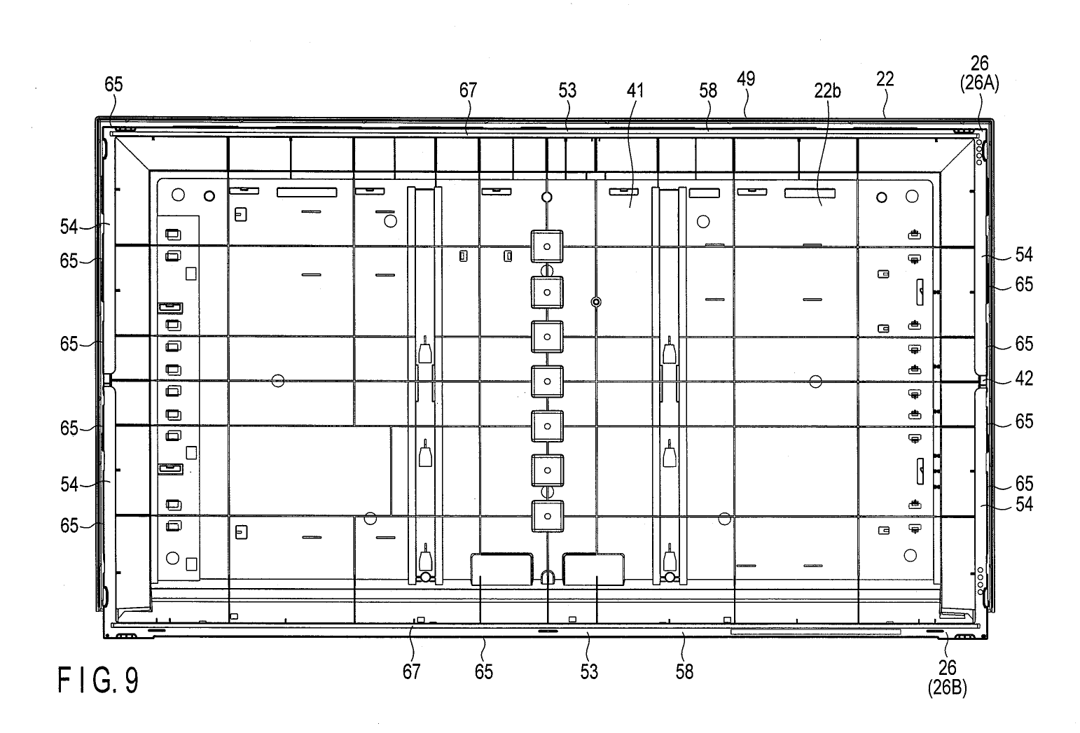

FIG. 9 is a front elevation showing the back cover 22 to which the frame part 26 is attached. As illustrated in FIG. 9, each of the pair of frame parts 26 is attached to the frame-like outer edge region 42 of the back cover 22. The pair of frame parts 26 is provided in a frame shape in the outer edge region 42.

The first portion 53 of the upper frame part 26A and the first portion 53 of the lower frame part 26B are substantially parallel with each other. Each of the second portions 54 of the upper frame part 26A is linearly set out with respect to a corresponding second portion 54 of the lower frame part 26B.

The pair of frame parts 26 attached to the outer edge region 42 of the back cover 22 is spaced apart from each other. In other words, distal ends of the second portions 54 of the upper frame part 26A face distal ends of the second portions 54 of the lower frame part 26B through gaps respectively. While the upper frame part 26A is attached to the back cover 22, the upper frame part 26A is not directly attached to the lower frame part 26B.

The pair of frame parts 26 attached to the outer edge region 42 of the back cover 22 is inside the outer frame 49 of the back cover 22. Therefore, the gap between the pair of frame parts 26 is covered from the outside by the outer frame 49 and other portions of the housing 10. Thus, the pair of frame parts 26 spaced apart from each other is covered by the housing 10.

As shown in FIG. 4, the frame part 26 comprises a first surface 57 and a second surface 58. The second surface 58 is opposite to the first surface 57. The first surface 57 is brought into contact with the sheet 32, and the first to third ribs 45 to 47 of the back cover 22. In other words, the frame part 26 is supported by the back cover 22, and the sheets 32 are interposed between the reflector 31 and the frame part 26. The sheets 32 are pushed onto the reflector 31 attached to the back cover 22 by the frame part 26.

The frame part 26 comprises a plurality of fourth ribs 61. The fourth ribs 61 are an example of ribs. The fourth ribs 61 protrude from the first surface 57. As shown in FIG. 8, the plurality of fourth ribs 61 extend along the first and second portions 53 and 54 of the frame part 26. Therefore, when the pair of frame parts 26 is attached to the back cover 22, the plurality of fourth ribs 61 are set out in a frame shape.

As illustrated in FIG. 4, the fourth ribs 61 are fit into the engaging portions 51 of the back cover 22. The engaging portions 51 control the movement of the frame part 26 which is parallel with the outer edge portion 42 of the back cover 22 by engaging with the fourth ribs 61.

FIG. 8 indicates that the frame part 26 further comprises a plurality of fifth ribs 62. The fifth ribs 62 are integrally formed with the fourth ribs 61. The fifth ribs 62 extend in a direction substantially orthogonal to the fourth ribs 61. Portions in which the fourth and fifth ribs 61 and 62 intersect with each other may be formed cylindrically, for example. Each of these intersecting portions is, for example, pushed by an inject pin when the frame part 26 is removed from a metallic mold.

FIG. 7 illustrates that some of the plurality of second ribs 46 of the back cover 22 each comprise a groove 64. When the frame part 26 is attached to the back cover 22, the fifth rib 62 is fit into the groove 64. The groove 64 controls the movement of the frame part 26 which is parallel with the outer edge region 42 of the back cover 22 by engaging with the fifth rib 62.

As shown in FIG. 4, the frame 26 comprises a plurality of surrounding portions 65. The surrounding portions 65 could be also referred to as, for example, circumference portions, inner frame portions or enclosures. The surrounding portions 65 protrude from an outer circumferential edge of the second surface 58, and are set out in a frame shape.

A buffer 67 is attached to the second surface 58 of each of the pair of frame parts 26. The buffer 67 is, for example, synthetic rubber or a sponge. The buffer 67 extends along the first portion 53 of the frame part 26. The buffer 67 may be also in the second portions 54.

The panel 11 is supported in the frame part 26 through the buffer 67. In other words, the buffer 67 intervenes between the panel 11 and the frame part 26. The panel 11 is interposed between the front cover 23 and the frame part 26. For example, other buffers may intervene between the front cover 23 and the panel 11.

The panel 11 is surrounded by the surrounding portions 65 and is supported in the pair of frame parts 26. The surrounding portions 65 inhibit the displacement of the panel 11 with respect to the frame part 26, and are utilized for determining the position of the panel 11. The upper frame part 26A supports two of four corners of the panel 11. The lower frame part 26B supports the other two corners of the panel 11. In other words, the four corners of the panel 11 are supported in the upper frame part 26A and the lower frame part 26B by two corners corresponding to each of the frame parts.

The pair of frame parts 26 intervene between the panel 11 and the sheets 32. Therefore, a gap is left between the panel 11 and the sheets 32 in order to inhibit the panel 11 from coming into contact with the sheets 32.

As shown in FIG. 8, the frame part 26 comprises a plurality of first openings 71. The first openings 71 are an example of a second engaging portion. The first openings 71 are slits which are in the first portion 53 and extend along the longitudinal direction of the first portion 53. The first openings 71 may be also in the second portions 54.

As shown in FIG. 3, the sheet 32 comprises a plurality of tabs 73. The tabs 73 protrude in parallel with the sheet 32 from an outer edge of the sheet 32. Some of the plurality of tabs 73 each comprise a second opening 74. The second opening 74 is a slit which extends along the outer edge of the sheet 32 comprising the tabs 73.

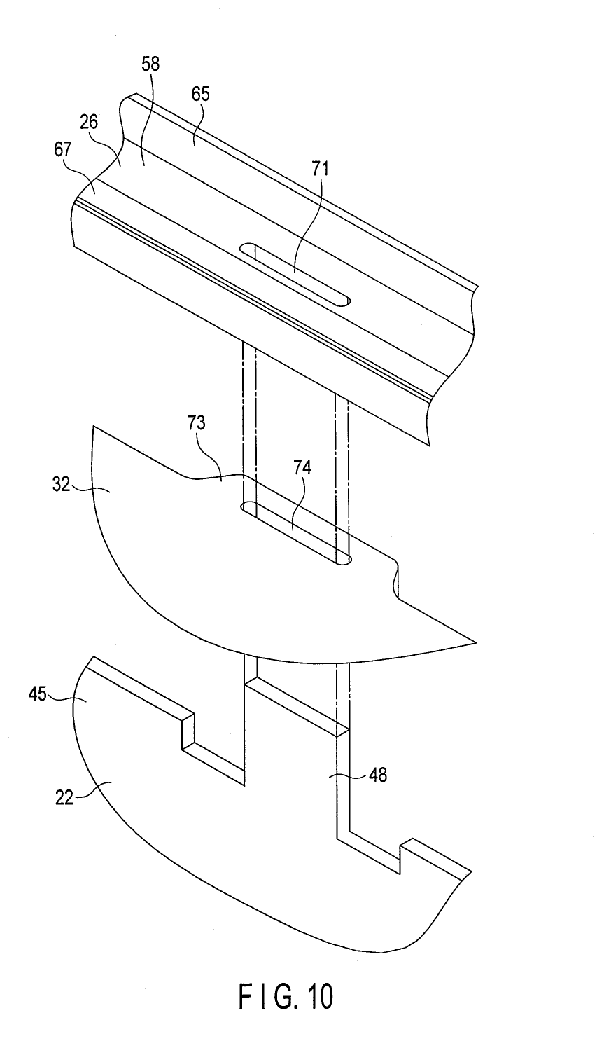

FIG. 10 is a perspective illustration showing a part of the frame part 26, the sheet 32 and the first rib 45. As shown in FIG. 10, the first opening 71 of the frame part 26, the second opening 74 of the sheet 32, and the projection 48 of the first rib 45 correspond to each other.

When the sheet 32 is piled on the reflector 31 attached to the back cover 22, the projection 48 is inserted into the second opening 74. In other words, the tab 73 of the sheet 32 engages with the projection 48.

When the frame part 26 is attached to the back cover 22, the projection 48 is inserted into the first opening 71. In other words, the first opening 71 engages with the projection 48. By attaching the frame part 26 to the back cover 22, the tab 73 of the sheet 32 is sandwiched and supported by the first rib 45 of the back cover 22 and the frame part 26. The fourth rib 61 of the frame part 26 extends avoiding the tab 73.

A lower end of the back cover 22 comprises a plurality of pins. These pins protrude toward the front cover 23. The lower frame part 26B comprises a plurality of holes corresponding to the pins of the back cover 22. When the lower frame part 26B is attached to the back cover 22, the pins are inserted into the holes. These holes and pins control the movement of the frame 26 which is parallel with the outer edge region 42 of the back cover 22.

When the upper frame part 26A is to be attached to the lower side of the outer edge region 42 to which the lower frame part 26B should be attached, the pins make contact with the upper frame part 26A. This inhibits the upper frame part 26A and the lower frame part 26B from being wrongly attached.

The above-explained electronic apparatus 1 is controlled by the driver IC. In the electronic apparatus 1, the panel 11 displays an image on the screen surface 11a. The LEDs of the back lights 33 emit light toward the panel 11. The light emitted by the LEDs is optically processed in various ways by the plurality of sheets 32 between the panel 11 and the back lights 33, and permeates the panel 11. Thus, the screen surface 11a of the panel 11 displays a light image illuminated by the back lights 33.

In the electronic apparatus 1 of the first embodiment, the panel 11 is spaced apart from the sheets 32 by the pair of frame parts 26. In other words, the frame-like member which separates the panel 11 from the sheets 32 is divided into a plurality of members. Further, the pair of frame parts 26 is spaced apart from each other. Therefore, the frame part 26 can be downsized compared with a case where the above frame-like member is formed as one unit. Thus, the material cost and metallic mold cost of the frame part 26 can be reduced. Moreover, as the handling of the frame part 26 becomes easy, the operation efficiency is improved. Thus, the breakage of the frame part 26 during the manufacturing process is reduced, and the yield rate is improved. In addition, the storage and the transportation of the frame part 26 become easy, and thus, the storage and transportation costs can be decreased. Therefore, the production cost of the electronic apparatus 1 can be reduced.

The housing 10 covers the pair of frame parts 26 spaced apart from each other. This inhibits the light of the back lights 33 from leaking into the outside through the gap between the pair of frame parts 26, and also inhibits foreign substances such as dusts from put into the gap between the panel 11 and the sheets 32.

The frame part 26 comprises the fourth and fifth ribs 61 and 62. This enhances the strength of the frame part 26, and inhibits the frame part 26 from being twisted. Thus, the frame part 26 is configured to support the panel 11 flatly. In addition, the fourth ribs 61 engage with the engaging portions 51 of the back cover 22 to control the movement of the frame part 26. This inhibits, for example, the frame part 26 from being dropped during the manufacturing process, and the panel 11 supported by the frame part 26 from being misaligned with respect to the sheets 32.

The sheets 32 engage with the projections 48 of the back cover 22. This inhibits, for example, the sheets 32 from being misaligned with respect to the back cover 22 during the manufacturing process. The projections 48 may be in the frame part 26. The first openings 71 may be in the back cover 22.

The projection 48 is inserted into the second opening 74 of the sheets 32. This easily prevents the displacement of the sheets 32. Further, by inserting the projection 48 into the first opening 71 of the frame part 26, the positions of the back cover 22 and the frame part 26 can be determined.

The sheet 32 comprises the tab 73 sandwiched and supported by the back cover 22 and the frame part 26. This inhibits the sheet 32 from being misaligned with respect to the back cover 22 and the frame part 26.

The buffer 67 is interposed between the panel 11 and the frame part 26. This inhibits the panel 11 from being broken. Moreover, the buffer 67 prevents slip, and inhibits the panel 11 from being misaligned with respect to the frame part 26. The buffer 67 also blocks the light leaking from the gap between the panel 11 and the frame part 26.

The frame 26 part supports the corners of the panel 11. This makes the position determination of the panel 11 with respect to the frame part 26 easy. In addition, each of the upper frame part 26A and the lower frame part 26B supports corresponding two corners of the panel 11. This facilitates the position determination of the frame part 26 with respect to the panel 11, and improves the strength of the frame part 26.

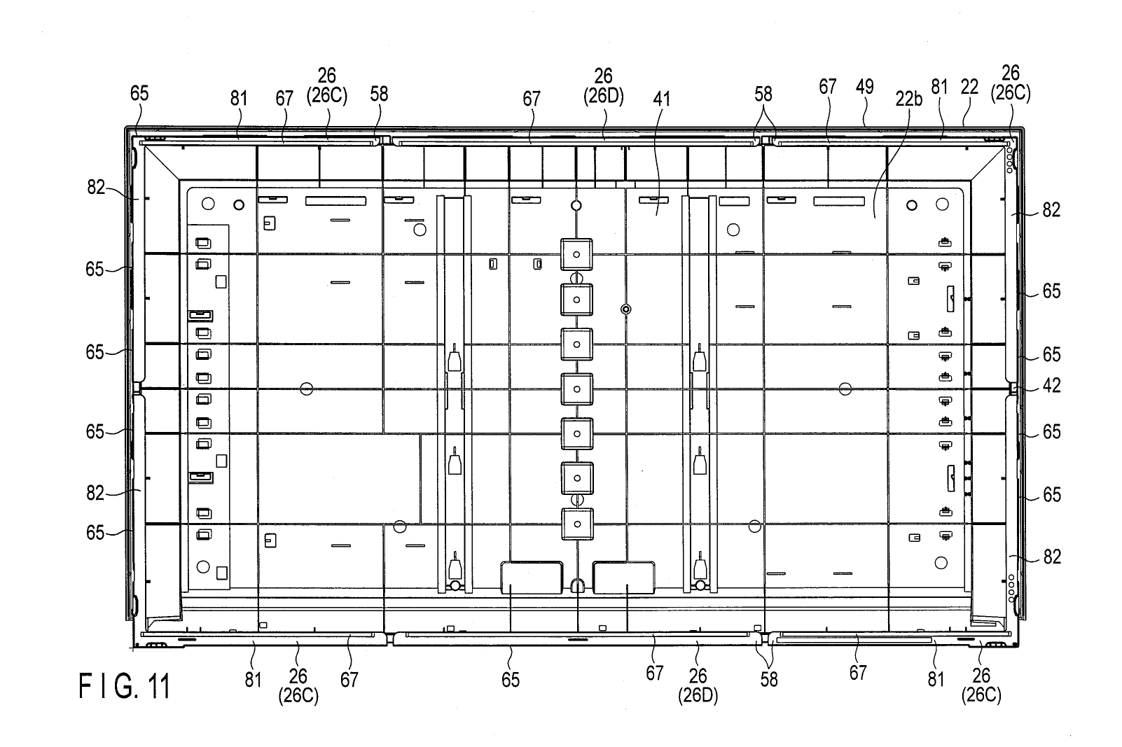

Next, a second embodiment is explained with reference to FIG. 11. In at least one of the embodiments disclosed below, structural elements having the same function as the electronic apparatus 1 of the first embodiment are denoted by the same reference numerals. Further, a part or all of explanations of such structural elements may be omitted.

FIG. 11 is a front elevation showing a back cover 22 and a plurality of frame parts 26 according to the second embodiment. As shown in FIG. 11, the plurality of frame parts 26 comprises four corner frame members 26C, and two side frame members 26D. In the following descriptions, when explanation is common to the corner frame members 26C and the side frame members 26D, the corner frame members 26C and the side frame members 26D are inclusively referred to as “frame part 26”.

Each of the corner frame members 26C comprises a first portion 81 and a second portion 82. The first portion 81 is a portion extending laterally. The second portion 82 is a portion extending longitudinally.

Each of the first and second portions 81 and 82 is formed into a rectangular plate-shape (bar-shape). A length of the first portion 81 is substantially equal to a length of the second portion 82. The second portion 82 extends from one end of the first portion 81. The second portion 82 is substantially orthogonal to the first portion 81. Thus, the corner frame members 26C are formed into L-shapes.

The side frame members 26D are formed into rectangular plate-shapes (bar-shapes). A length and width of each side frame member 26D are substantially equal to the first and second portions 81 and 82 of each corner frame member 26C. The length and width of each side frame member 26D may be different from the first and second portions 81 and 82 of each corner frame member 26C.

Each of the plurality of frame parts 26 is attached to a frame-like outer edge region 42 of the back cover 22. Therefore, the plurality of frame parts 26 are provided in a frame shape. Specifically, the four corner frame members 26C are at four corners of the outer edge region 42 respectively. Each of the two side frame members 26D is in an upper or lower side of the outer edge region 42 between the corner frame members 26C.

The plurality of frame parts 26 attached to the outer edge region 42 of the back cover 22 are spaced apart from each other. In other words, an end of the second portion 82 of each of the corner frame members 26C faces an end of the second portion 82 of a corresponding corner frame member 26C through a gap. An end of the first portion 81 of each of the corner frame members 26C faces an end of a corresponding side frame member 26D through a gap.

The four corner frame members 26C support the four corners of the panel 11 respectively. In other words, each of the four corners of the panel 11 is supported by a corresponding corner frame member 26C. On the other hand, each of the two side frame members 26D supports an upper or lower edge of the panel 11.

According to an electronic apparatus 1 of the second embodiment, it is possible to easily determine the position of the frame part 26 with respect to the panel 11 by a structure in which one of the corner frame members 26C supports one corner of the panel 11. Moreover, the frame part 26 can be downsized, and can be easily handled, stored and transported. By conforming the shapes of the four corner frame members 26 to each other, the production cost can be reduced.

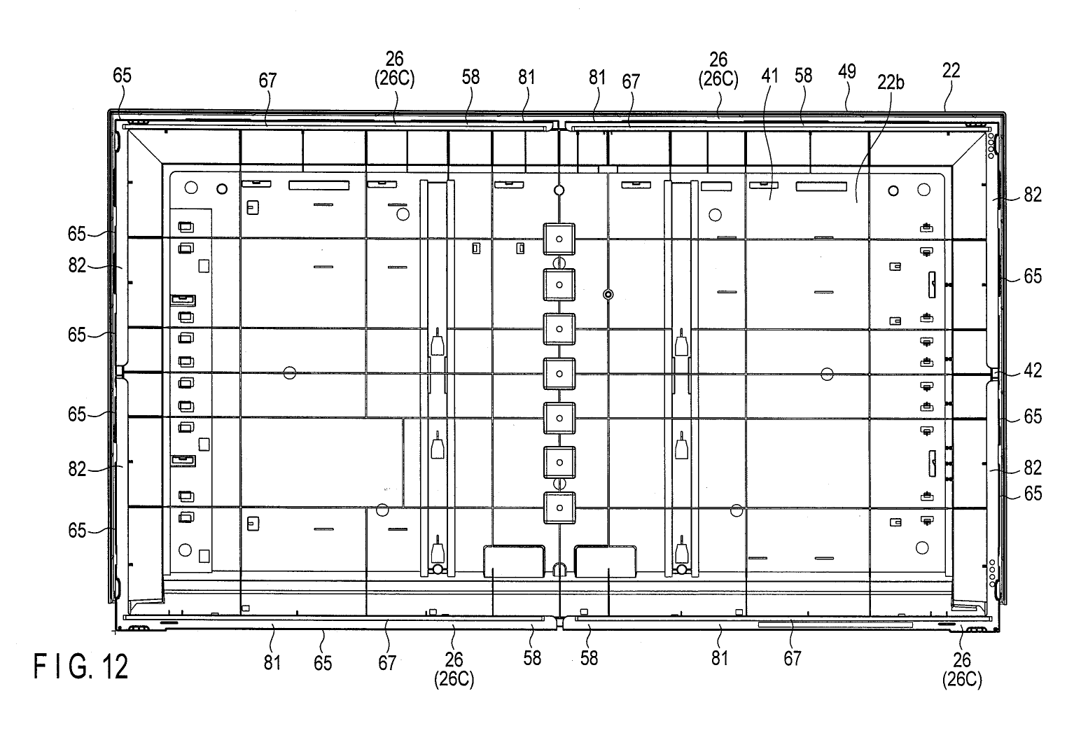

A third embodiment is explained by reference to FIG. 12. FIG. 12 is a front elevation showing a back cover 22 and a plurality of frame parts 26 according to the third embodiment. As illustrated in FIG. 12, the frame parts 26 of the third embodiment comprise four corner frame members 26C only, and do not comprise side frame members 26D. The four corner frame members 26C support four corners of the panel 11 respectively.

As indicated in FIG. 12, a first portion 81 of each corner frame member 26C is longer than a second portion 82. An end of the first portion 81 of each of the corner frame members 26C faces an end of the first portion 81 of an adjacent corner frame member 26C through a gap. Similarly, an end of the second portion 82 of each of the corner frame members 26C faces an end of the second portion 82 of an adjacent corner frame member 26C through a gap. A distance between the facing first portions 81 is substantially equal to a distance between the facing second portions 82.

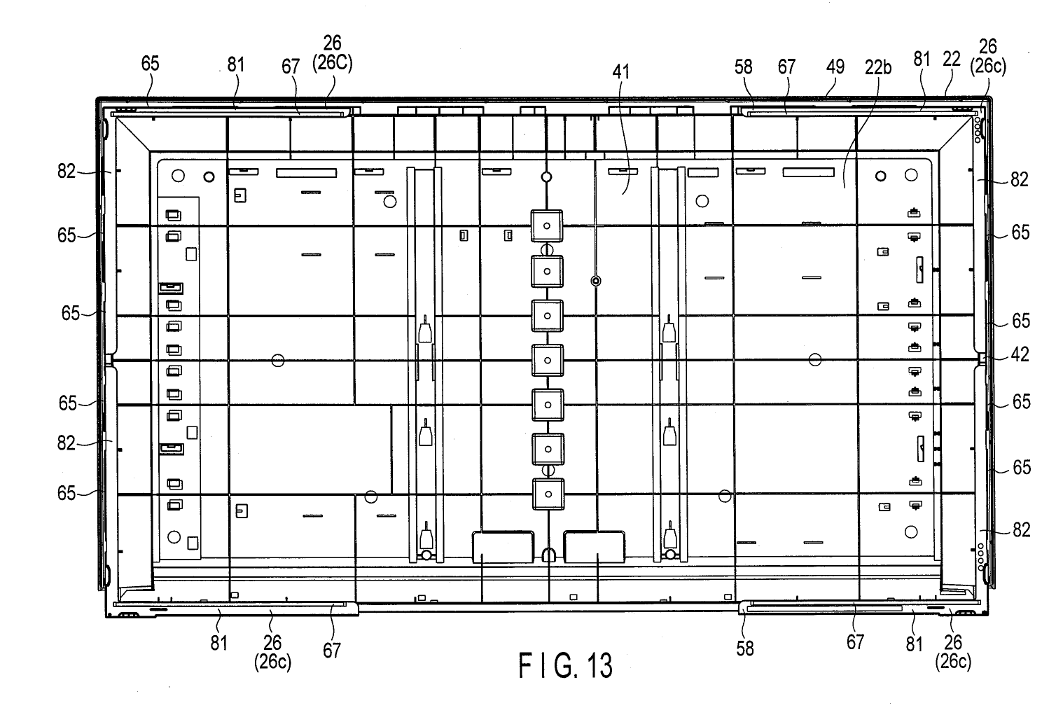

FIG. 13 is a front elevation showing an example of transformation of the back cover 22 and the plurality of frame parts 26 according to the third embodiment. As illustrated in FIG. 13, a length of the first portion 81 of the corner frame member 26C may be substantially equal to a length of the second portion 82. In this case, the distance between the facing first portions 81 is longer than the distance between the facing second portions 82. A larger gap between the first portions 81 than a gap between the second portions 82 is covered by an outer frame 49 and other portions of a housing 10. This prevents light of a back light 33 from leaking into the outside of the housing 10.

According to an electronic apparatus 1 of the third embodiment, similarly to the second embodiment, it is easy to determine the position of the frame part 26 with respect to the panel 11. Moreover, the frame part 26 can be easily handled, stored and transported. By reducing the size of the frame part 26 as shown in the transformation example, the material cost of the electronic apparatus 1 can be decreased.

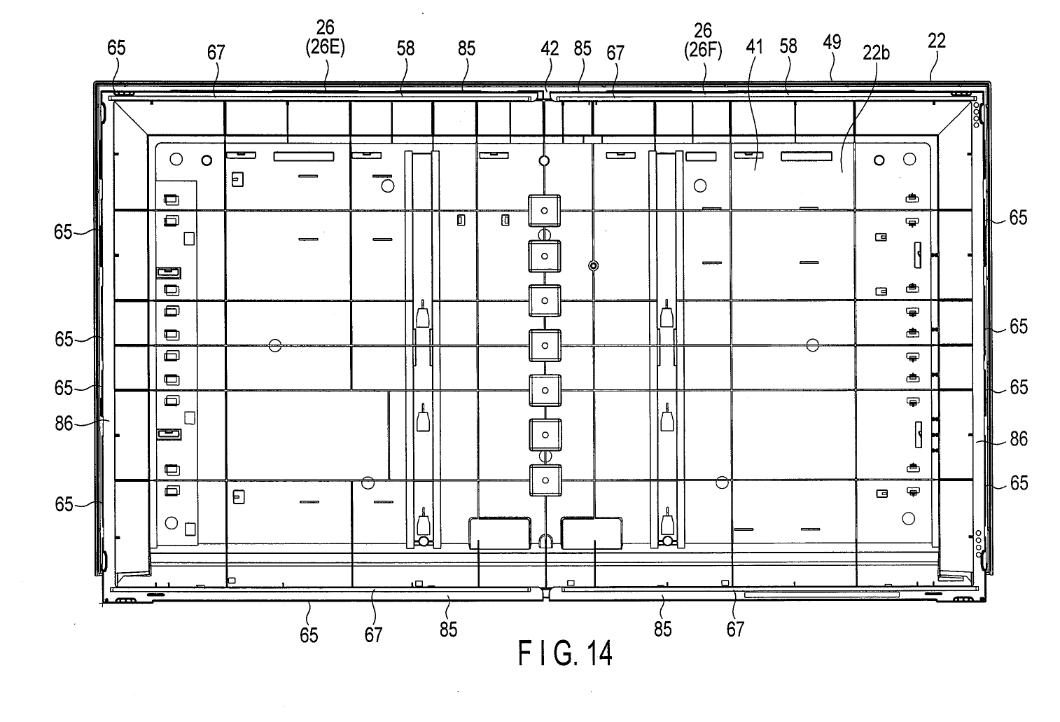

Next, a fourth embodiment is explained with reference to FIG. 14. FIG. 14 is a front illustration showing a back cover 22 and a plurality of frame parts 26 according to the fourth embodiment. FIG. 14 indicates that the frame parts 26 of the fourth embodiment comprise a left frame member 26E and a right frame member 26F.

Each of the left frame member 26E and the right frame member 26F comprises a pair of first portions 85 and a second portion 86. The first portions 85 are portions extending laterally. The second portion 86 is a portion extending longitudinally.

Each of the first and second portions 85 and 86 is formed into a rectangular plate-shape (bar-shape). The pair of first portions 85 extends toward a substantially same direction from ends of the second portion 86 respectively. Therefore, the pair of first portions 85 extends substantially in parallel with each other. The first portions 85 are substantially orthogonal to the second portion 86. Thus, each of the left frame member 26E and the right frame member 26F is formed into a U-shape.

The left frame member 26E supports two of four corners of a panel 11. The right frame member 26F supports the other two of the four corners of the panel 11. In other words, the four corners of the panel 11 are supported in the left frame member 26E and the right frame member 26F by two corners for each frame part.

According to an electronic apparatus 1 of the fourth embodiment, similarly to the first embodiment, the left frame member 26E and the right frame member 26F support the corners of the panel 11 by two corners. This makes the position determination of the frame part 26 with respect to the panel 11 easy, and enhances the strength of the frame part 26.

According to at least one of the above-described electronic apparatuses, the plurality of frame parts interposed between the panel and the sheets are attached to the housing while the frame parts are spaced apart from each other. This can reduce the cost for manufacturing the electronic apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the first to third ribs 45 to 47 may be in the front cover 23. In this case, the frame parts 26 are attached to the front cover 23.

What is claimed is:

1. An electronic apparatus comprising:
a housing;
a panel within the housing;
a back light configured to emit light toward the panel;
a sheet between the panel and the back light; and
a plurality of frame parts spaced part from each other between the panel and the sheet.

2. The electronic apparatus of claim 1, wherein the housing covers the plurality of frame parts spaced apart from each other.

3. The electronic apparatus of claim 1, wherein
the frame parts comprise a rib, and
the housing comprises an engaging portion configured to control a movement of the frame parts attached to the housing by engaging with the rib.

4. The electronic apparatus of claim 1, wherein
the housing comprises a first engaging portion,
the frame parts comprises a second engaging portion engaging with the first engaging portion, and
the sheet engages with at least either the first or second engaging portion.

5. The electronic apparatus of claim 4, wherein
one of the first and second engaging portions comprises a projection, and the other comprises a first opening into which the projection is inserted, and
the sheet comprises a second opening into which the projection is inserted.

6. The electronic apparatus of claim 1, wherein the sheet comprises a tab protruding from an outer edge of the sheet, and interposed and supported by the housing and the frame parts.

7. The electronic apparatus of claim 1, further comprising a buffer interposed between the panel and the frame parts.

8. The electronic apparatus of claim 1, wherein the plurality of frame parts support corners of the panel.

9. The electronic apparatus of claim 8, wherein
the panel has a rectangular shape, and
two of the four corners of the panel are supported in one of the frame parts in a corresponding manner.

10. The electronic apparatus of claim 8, wherein
the panel comprises four corners, and
the plurality of frame parts comprise four frame members configured to support the four corners of the panel respectively.
